(19) United States
(12) Patent Application Publication
(10) Pub. No.: US 2026/0323401 A1
(43) Pub. Date: Oct. 15, 2026

(54) System And Method for Efficient Use Of Redundant Global Networks

(71) Applicant: Google LLC, Mountain View, CA (US)

(72) Inventors: Jonathan Edward Zolla, San Francisco, CA (US); Subhasree Mandal, San Jose, CA (US); Chi-Yao Hong, Sunnyvale, CA (US); Aman M. Shaikh, Berkeley Heights, NJ (US); Namrata Pralhad Kadam, New York, NJ (US); Charith Dhanshka Wickramaarachchi, San Jose, CA (US)

(21) Appl. No.: 19/637,232

(22) Filed: Apr. 2, 2026

Related U.S. Application Data
(60) Provisional application No. 63/785,917, filed on Apr. 9, 2025.

(51) Int. Cl. H04W 28/20

(52) U.S. Cl. CPC H04W 28/20

(57) ABSTRACT

The present disclosure provides a controller, local to network edge of a core sharded network. The controller provides a layer of SDN control on top of traditional routing protocols, such as border gateway protocol (BGP). This architecture interacts cleanly with traditional routing to provide three layers of protection. First, the architecture provides path diversity that can be leveraged by in-band technologies for near instantaneous failure recovery for a category of outages that result in packet loss. Second, standard routing protocols can converge to resolve traditional failures, e.g. lack of BGP reachability. Third, an SDN-aware layer of the architecture provides a set of preferred routes that enable the controller to enable/disable specific network shards for particular flows.

### CROSS REFERENCE TO RELATED APPLICATIONS

The present application claims the benefit of the filing date of U.S. Provisional Patent Application No. 63/785,917 filed Apr. 9, 2025, the disclosure of which is hereby incorporated herein by reference.

### BACKGROUND

Wide Area Networks (WANs) are inherently global, and pose a significant reliability risk for software services that depend on the network. As Software Defined Networking (SDN) has become more commonplace, providers have moved towards deploying global software controllers to improve the efficiency of their WANs, at the expense of introducing a new global failure risk for the network. As a result, SDN systems have introduced a tradeoff between fast convergence and availability. These outages pose significant financial risk to operators of large WANs, including cloud providers, telecom providers, and consumer software-as-a-service (SAAS) software providers.

One approach to addressing this issue is sharding, which includes building parallel WANs to serve as backup, each parallel WAN having independent data, control, and management planes. With this approach, each slice can operate an independent control plane, and reduce the impact of a controller or routing issue within a particular shard. Sharding a network in this manner poses problems with regards to how traffic is admitted across the individual shards. For example, failure of a shard can cause large changes to inputs of the global controllers on other shards, and moving traffic before these changes have been accounted for in the control plane can result in congestion or loss. As another example, different classes of traffic have different requirements with regards to availability, latency, etc. Not accounting for these differences can lead to inefficient deployment of network capacity. As a further example, aggressively moving traffic under small failures can amplify a smaller outage, while not accounting for all categories of issues could reduce the benefits of sharding.

### BRIEF SUMMARY

Aspects of the disclosure provide a controller positioned at the network edge of a core sharded network. The controller overlays a software defined networking control layer on top of conventional routing protocols such as Border Gateway Protocol. The architecture interoperates with traditional routing to deliver multiple layers of protection. Path diversity is provided and can be utilized by in band mechanisms for near instantaneous recovery from certain packet loss related failures. Conventional routing protocols are able to converge to address standard failures such as loss of Border Gateway Protocol reachability. An SDN aware layer supplies preferred routing paths, allowing the controller to selectively enable or disable specific network shards for particular traffic flows.

An aspect of the disclosure provides a system including one or more processors in communication with a plurality of global networks, the one or more processors configured to receive respective bandwidth allocations for each of the plurality of global networks, receive traffic demand corresponding to one or more flows to be sent from a source to a destination over the global networks, determine, based on the respective bandwidth allocations and the traffic demand, weights for allocating the one or more flows across the plurality of global networks, and distribute the one or more flows according to the determined weights.

In some examples, the one or more processors comprise a software defined network (SDN) controller.

In some examples, the one or more processors further comprise a route installer, wherein the SDN controller is configured to communicate the determined weights to the route installer for distributing the one or more flows.

In some examples, the route installer is configured to convert the weights received from the SDN controller into standardized networking protocol routes.

In some examples, the route installer is further configured to communicate the standardized networking protocol routes to a standardized networking routing application.

In some examples, the SDN controller is configured to determine aggregate bandwidth limits across the plurality of shards, the aggregate bandwidth limits being used to determine the weights.

In some examples, the one or more processors comprise a service level objective (SLO) tracker, wherein the SLO tracker receives demands and provides information encoding a priority of the demands.

In some examples, each of the plurality of shards has a respective broker, the respective broker configured to receive the per-shard demand and determine bandwidth allocations based on the per-shard demand and observed path splits.

Another aspect of the disclosure provides a method of allocating flows among a plurality of global networks, the method comprising receiving, at one or more processors, respective bandwidth allocations for each of the plurality of shards, receiving, at the one or more processors, traffic demand corresponding to one or more flows to be sent from a source to a destination over the global network, determining, at the one or more processors based on the respective bandwidth allocations and the traffic demand, weights for allocating the one or more flows across the plurality of shards, and distributing, by the one or more processors, the one or more flows according to the determined weights.

In some examples, the one or more processors comprise a software defined network (SDN) controller.

In some examples, the one or more processors further comprise a route installer, and the method further comprises communicating, by the SDN controller, the determined weights to the route installer for distributing the one or more flows.

In some examples, the method further comprises converting, by the route installer, the weights received from the SDN controller into standardized networking protocol routes.

In some examples, the method further comprises communicating, by the route installer, the standardized networking protocol routes to a standardized networking routing application.

In some examples, the method further comprises determining, by the SDN controller, aggregate bandwidth limits across the plurality of shards, the aggregate bandwidth limits being used to determine the weights.

In some examples, the one or more processors comprise a service level objective (SLO) tracker, wherein the SLO tracker receives demands and provides information encoding a priority of the demands.

In some examples, each of the plurality of shards has a respective broker, the respective broker configured to receive the per-shard demand and determine bandwidth allocations based on the per-shard demand and observed path splits.

Yet another aspect of the disclosure provides a non-transitory computer-readable medium storing instructions that, when executed by one or more processors, cause the one or more processors to perform operations for allocating flows among a plurality of global networks, the operations comprising receiving respective bandwidth allocations for each of the plurality of shards, receiving traffic demand corresponding to one or more flows to be sent from a source to a destination over the global network, determining, based on the respective bandwidth allocations and the traffic demand, weights for allocating the one or more flows across the plurality of shards, and distributing the one or more flows according to the determined weights.

In some examples, the one or more processors comprise a software defined network (SDN) controller. In some examples, the one or more processors further comprise a route installer, and the operations further comprise communicating, by the SDN controller, the determined weights to the route installer for distributing the one or more flows.

In some examples, the operations further comprise converting, by the route installer, the weights received from the SDN controller into standardized networking protocol routes.

In some examples, the operations further comprise communicating, by the route installer, the standardized networking protocol routes to a standardized networking routing application.

### BRIEF DESCRIPTION OF THE DRAWINGS

FIG. 1 is a block diagram illustrating a global network with a sharded global wide area network (WAN) according to aspects of the disclosure.

FIG. 2 is an operational diagram illustrating handling of shard failures according to aspects of the disclosure.

FIG. 3 illustrates an example topology according to aspects of the disclosure.

FIG. 4 illustrates an example of how data traffic will flow between fabrics via the sharded core according to aspects of the disclosure.

FIG. 5 illustrates an example of cluster-to-cluster route propagation for unsharded traffic, according to aspects of the disclosure.

FIG. 6 illustrates an example of cluster-to-cluster route propagation for the sharded traffic, according to aspects of the disclosure.

FIG. 7 is a block diagram of an example global and regional control plane, according to aspects of the disclosure.

FIG. 8 is a block diagram of the bandwidth enforcer, according to aspects of the disclosure.

FIG. 9 provides a simplified view of the global and regional control plane components, according to aspects of the disclosure.

FIG. 10 illustrates an example of cross-shard edge gateway (route installer) communication, according to aspects of the disclosure.

FIGS. 11-15 illustrate an example of a shard failure and response by the SDN controller, according to aspects of the disclosure.

FIG. 16 is a flow diagram illustrating an example method of allocating flows among a plurality of shards in a global network according to aspects of the disclosure.

### DETAILED DESCRIPTION

The present disclosure provides a controller, local to network edge of a core sharded network. The controller provides a layer of SDN control on top of traditional routing protocols, such as border gateway protocol (BGP). This architecture interacts cleanly with traditional routing to provide three layers of protection. First, the architecture provides path diversity that can be leveraged by in-band technologies for near instantaneous failure recovery for a category of outages that result in packet loss. Second, standard routing protocols can converge to resolve traditional failures, e.g. lack of BGP reachability. Third, an SDN-aware layer of the architecture provides a set of preferred routes that enable the controller to enable/disable specific network shards for particular flows.

The controller may utilize state information from various controllers in the core sharded network to determine the most optimal amount of traffic to send to each of the available shards. In determining the optimal amount of traffic to send, the controller may further consider switch hardware constraints, including restrictions in the granularity traffic may be split. Moreover, the controller may prevent transient congestion during changes in state, including proactively signaling changes in demand to the global control planes.

The controller passes its determined load balancing ratios to a route installer, which is responsible for maintaining eBGP sessions with the edge border routers (EBRs), and translating that intent to BGP routes to achieve the desired effect. Splitting this functionality in such a manner ensures that the system can maintain last known good state via route installer, even if the more complicated, policy aware controller is to fail.

The route installer may be responsible for installing routes to border routers via eBGP. A set of routing policies allows for overlaying the SDN intent on top of traditional BGP routes from each shard. This design is based on creating a set of “Abstract next hop” prefixes for each remote edge network towards a given shard, such that every remote cluster prefix p effectively has per-shard Abstract next hops p-ANH1, p-ANH2, . . . p-ANHN.

The route installer programs preferred BGP next hops for a given cluster prefix, p for each shard that should be utilized, e.g. {p: p-ANH1, p-ANH3, p-ANH4} can be resolved by the border router to use only shards 1, 3, and 4, even if p is announced by all four shards.

This design allows reaction to some forms of shard failure without relying on programming from the controller. Because all traffic towards a cluster prefix has routes to all shards at the border router, in-band technologies are able to react very quickly to failures that manifest as dropped packets for a flow. The route resolution at the border router will only include shards that announce an abstract next hop, meaning that BGP issues that result in loss of routes to a particular shard can be resolved locally at the EBR without involvement from the SDN controller. That state is later observed by SDN controller so that it can incorporate the failure into its algorithm inputs.

The architecture described herein, as compared to existing solutions, accounts for a wider variety of failures within a particular shard, including those that would not traditionally be communicated via eBGP. Further, it is aware of business policies and service level objectives (SLOs). Moreover, it allows for more efficient network planning & deployment. The SDN controller can analyze and validate inputs from each shard control plane based on business logic that cannot be expressed as BGP policy. Controller failures can be bounded from causing further cascading failures. Tradeoffs cane be actively controlled, such as a tradeoff between the most effective way to utilize limited switch resources to best meet overall business policy goals. Further, upcoming changes to the sharded control plane can be actively signaled to avoid convergence issues when failing traffic between shards. Policy-aware behavior is provided without sacrificing faster reaction from traditional mechanisms, such as BGP routing.

Another advantage is the introduction of “Abstract next hop” prefixes, which additionally provides a mechanism to monitor each shard via active probing. Further, the architecture described herein is more resilient to global issues with BGP routing on an individual shard. For example, if a bad configuration push caused a single shard to announce more preferred routes than the other shards, other solutions may allow that shard to attract all traffic, possibly causing congestion. Because the architecture described herein uses preferred routes from the local SDN controller, it is not susceptible to such a global failure. Moreover, predictable behavior under failure allows for clear policies to capacity plan under shard failures.

According to some other examples, packet encapsulation may be used to direct traffic to specific subsets of shards, allowing more flexible programming at endpoints, e.g. end hosts, rather than being limited by switch capabilities. Further failure policy may be signaled to switches by any of a variety of techniques, such as via dynamic changes to BGP link bandwidth or alternative APIs. Moreover, protective load balancing (PLB) may be used to spread traffic across shards for in-band signaling and reaction to congestion. In some examples, BGP link bandwidth may be used to partially move traffic, emulating hypothetical impact of failover decisions to speed convergence.

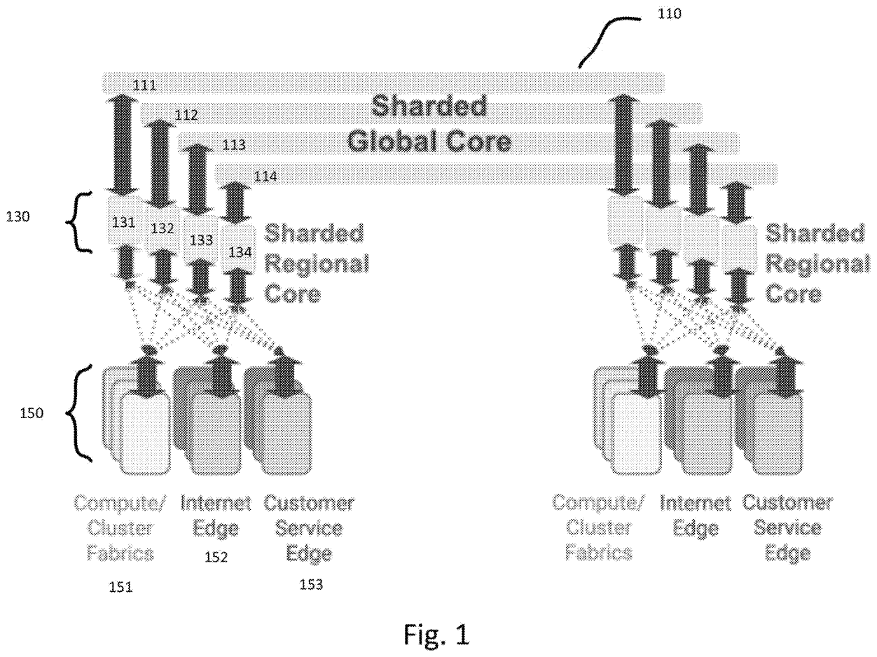

FIG. 1 is a block diagram illustrating a global network with a sharded global wide area network (WAN) according to aspects of the disclosure. Global core 110 may include data, control, and/or management planes for inter-region traffic. Regional cores 130 may include data, control, and/or management planes for traffic to, from, or within a specific region. Compute cluster edge networks 151 may include data, control, and/or management planes for traffic to, from, or within a specific zone. Internet edge 152 and customer service edge 153 may include data, control, and/or management planes for traffic to/from a network at a specific edge location. Global core 110 is sharded, and regional cores 130 are sharded. In the example shown, each regional shard 131, 132, 133, 134 in each regional core 130 interfaces with a corresponding global shard 111, 112, 113, 114 in the global core 110. While two regional cores 130 are shown, each including four shards, it should be understood that any number of regional cores may interface with the global core 110. Edge devices 150 interface with the regional cores 130. For example, each of the compute/cluster edge networks 151, internet edge 152, and customer service edge 153 may connect to all four shards 131-134 in its respective region. The interfacing may be established though application programming interfaces (API) with strong validation.

Sharding global core 110 and regional cores 130 may reduce outages caused by failures. Moreover, sharding the global core 110 and regional cores 130 improves network capacity scaling by adding capacity in the new shards using lower cost, scalable platforms.

The shards, including global shards 111-114 and regional shards 131-134, may be independent parallel networks. Each shard may have independent data, control, and management planes. Service level objectives (SLOs) may be met for all traffic. In the case of a single shard failure, traffic will move to other healthy shards. Appropriate failure modeling during planning will ensure that outage budgets for all SLOs continue to be met. As some classes of traffic have very large error budgets, this may mean that the SLO may not be met instantaneously during a shard failure. Sharding does not reduce the availability target for individual shards. When a flow is sharded, all of the available shards should offer equivalent behavior and reliability.

In some examples, shards may be deployed equally, such that traffic for sharded flows is equally distributed among the four shards. In other examples, shards can be deployed using weighting or other techniques. While in some implementations the shards can be physical shards, in other implementations the shards may be logical shards.

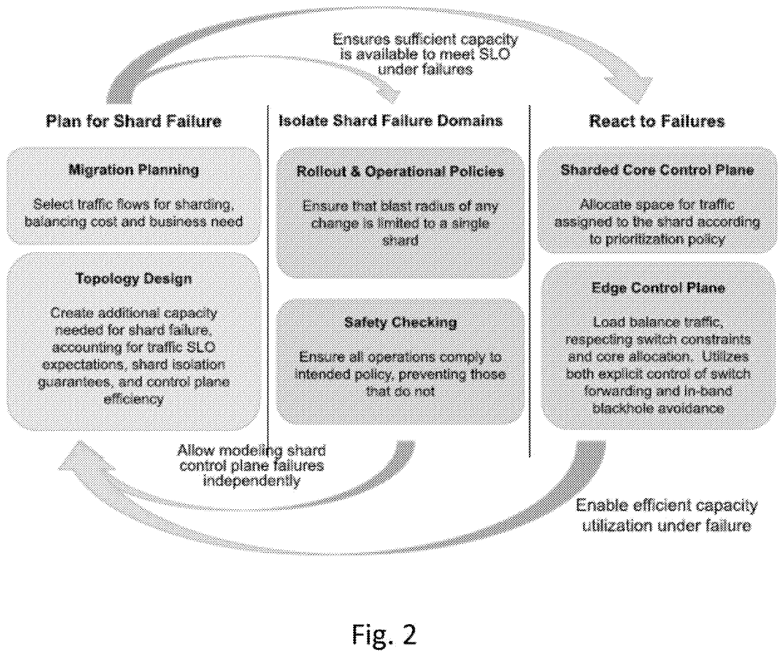

FIG. 2 is an operational diagram illustrating handling of shard failures. Handling a shard failure involves planning for shard failure, isolating shards to independent failure domains, and reacting to failures.

Planning for shard failure includes ensuring that there is sufficient capacity to meet a flow's target availability despite a shard failure. Migration planning includes selecting traffic flows for sharding, balancing considerations such as cost and business need. Topology design includes creating additional capacity needed for shard failure, accounting for traffic SLO expectations, shard isolation guarantees, and control plane efficiency.

Planning must be able to make reasonable assumptions about which types of failures happen concurrently in order to manage the additional cost of failure protection. Isolating shards facilitates this effort by making the shards as independent as possible, and enforcing this through rollout policies for sharded systems. For example, rollout and operational policies may ensure that a blast radius of any change is limited to a single shard. Safety checking systems ensure that operations comply with intended policies, and prevent operations that do not comply.

When a failure does occur, reacting to the failure should ensure that the control plane converges efficiently and safely. Sharded core control plane allocates space for traffic assigned to the shard according to prioritization policy. Edge control plane load balances traffic, respecting switch constraints and core allocation. Further, the edge control plane utilizes both explicit control of switch forwarding and in-band blackhole avoidance.

As an example, when a shard fails, the system works to converge to a safe allocation that avoids the failed shard. Such convergence may occur across multiple timescales. Within multiple round-trip-times (RTTs), in-band mechanisms can detect blackholing of flows hashed to the failed shard. These flows can adjust their hashing result such that they are redirected to one of the other shards to avoid blackholing. Within tens of seconds, the zonal SDN controller detects the issue and acknowledges it is best to remove traffic from the failed shard. It informs the global and regional control plane that additional traffic should be allocated on the functional shards to account for the loss of capacity on the failed shard. Within minutes, the global control plane allocation has converged, and the SDN controller programs an updated set of weights to the router via a cluster edge control plane. The result of the global outage is that services experience a short duration of disruption which is aligned with the availability target of the flow.

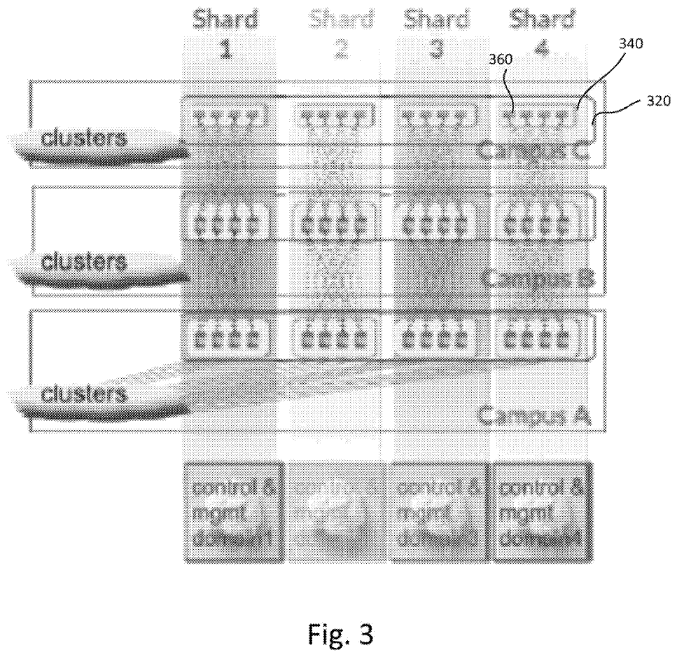

FIG. 3 illustrates an example topology. This example includes three campuses, wherein each campus includes a respective village 320. Each village includes a plurality of neighborhoods 340 connected to the same set of clusters in the campus. Each neighborhood includes a plurality of supernodes 360 deployed with sidelinks to handle planned or unplanned capacity asymmetry across the member supernodes. Each neighborhood 340 may belong to a different shard. The neighborhoods 340 in a village 320 may be unconnected to each other. A supernode 360 is a single abstract node for routing, such as a single chassis or a CLOS fabric. Transponder sharding at the chassis level isolates a shard from failure of the chassis commons such as the controller, fans, and power supply and management systems. It further allows for restricting software upgrades to be applied to different shards sequentially. It can help enhance vendor and optical band diversity in the network. Each village has N neighborhoods in N different shards. Each neighborhood connects only to the corresponding neighborhoods in the same shard in the peering villages.

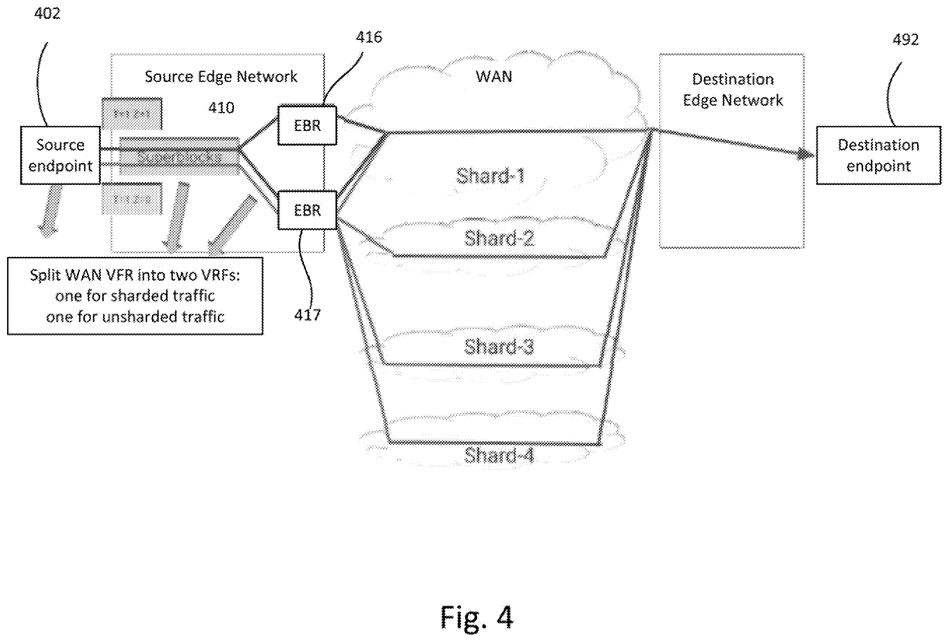

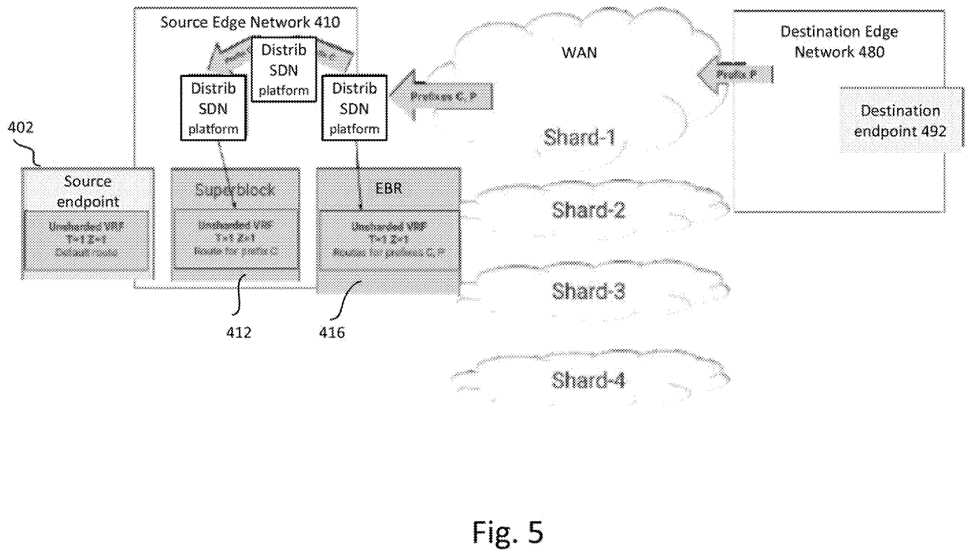

FIG. 4 illustrates an example of how data traffic will flow between edge networks via the sharded core. The source edge network may include one or more superblocks and one or more edge border routers (EBRs) 416, 417. The superblock may include metadata or other information about the source edge network. The EBRs 416, 417 may be switches or routers that connect a datacenter network to the global WAN, represented in FIG. 5 as core shards Shard-1 through Shard-4. When a source host 402 wants to send traffic to a destination host 492 via the global core, it will have to decide whether the traffic should be unsharded or sharded. The source host 402 may use a bit, such as the Z bit, in the packet header to make this decision according to rules provided by a bandwidth enforcer, and the entire source edge network 410 will honor this decision. To achieve this, every forwarding element from the source host 402 to edge network border routers (EBR) 416, 417 connected to the global core may use two virtual routing and forwarding tables (VRFs) while forwarding data packets, such that one table is utilized for sharded traffic and the other is utilized for unsharded traffic. The unsharded traffic may consult a first VRF for packets with (T=1, Z=1) marking while packets with (T=1, Z=0) may use a separate VRF dedicated for the sharded traffic.

FIG. 5 illustrates an example of cluster-to-cluster route propagation for the unsharded traffic, with routes propagating from the destination edge network to the source edge network with core sharding. Destination host 480 is covered by a prefix P. B4 will carry prefix P all the way to the source edge network before handing the prefix over to EBR supernodes 416 over eBGP sessions. Each EBR supernode 416 is controlled by a dedicated distributed software defined networking (SDN) platform domain, and an application receives and processes the route received over eBGP sessions. The application, after processing this route, will pass it to another application responsible for programming the switches underpinning EBR supernodes. A separate and dedicated distributed SDN platform domain is in charge of every superblock and spineblock in an edge network or fabric. Furthermore, a separate domain running a centralized inter-block routing (IBR-C) application takes care of control-plane communication between SDN domains in charge of superblocks and EBR supernodes. The EBR also receives a prefix C, “covering” P and all other prefixes corresponding to various edge networks. The inter-block routing application learns the covering prefix C from EBR supernodes before passing it onto every superblock 412 SDN domain. Applications running as part of the superblock SDN domain program the superblock switches, including the top-of-rack (ToR) switches of the source host 410. The source host 410, like every host in every cluster, uses a default route to send data traffic to its ToR switch. This route propagation from the destination edge network 480 to the source edge network 410 via B4 will continue to work as it works now. However, the virtual routing and forwarding tables (VRFs) on the source edge network that contain these routes will only be used for the unsharded traffic.

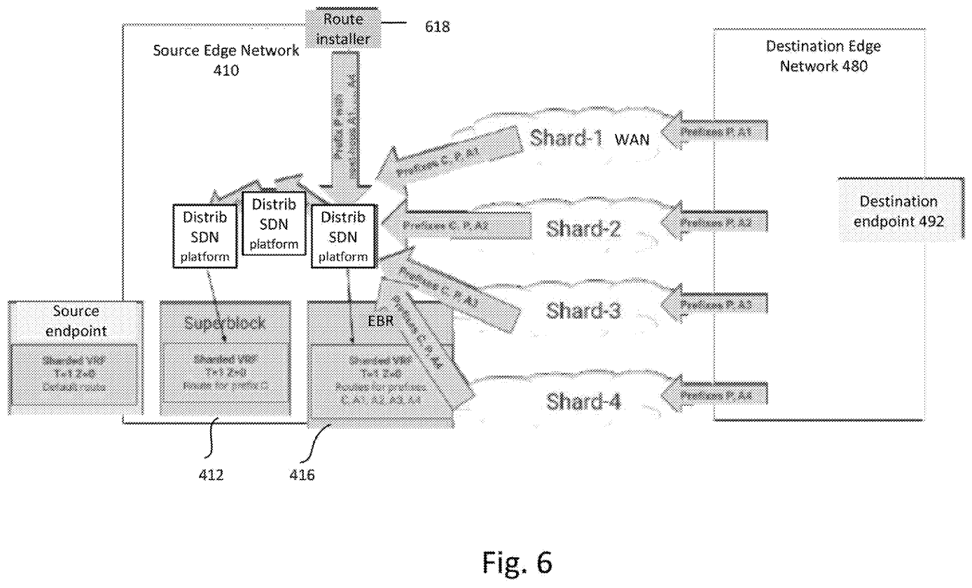

FIG. 6 illustrates an example of cluster-to-cluster route propagation for the sharded traffic. The destination edge network 480 will start announcing prefix P to connected shards. Apart from prefix P, the edge network will also announce four prefixes (A1, . . . , A4) called abstract prefixes. These abstract prefixes will be unique and non-overlapping for every edge network and shard pair, which allows for selectively enabling or disabling a shard on a per edge network basis, and for sending probe traffic through a specific shard deterministically, facilitating availability and performance measurements of end-to-end network paths spanning edge networks and global core shards. Once announced, prefix P and abstract prefixes A1, . . . ,A4 will traverse shard(s) and reach EBR supernodes 416 in the source edge network 410. The EBR 416 may also establish a BGP session with a per-edge-network bandwidth enforcer component called Cross Shard Edge Gateway (route installer) 618. route installer 618 will advertise the same prefix P to EBR 416 with the next-hop attribute set to IP address(es) matching abstract prefixes. EBR 416 may consult routes learned from the shards for the abstract prefixes A1, . . . , A4. By combining the route installer-learned route for prefix P with the shard-learned routes for the abstract prefixes, the EBR 416 can send traffic to the destination edge network 480 through all shards. The source EBR supernode will be able to use a particular shard i for traffic destined to prefix P if two conditions are met: (1) the supernode receives the abstract prefix A i from shard I; and (2) route installer's route announcement for prefix P lists an address matching A i as one of the BGP next-hops. These conditions also allow the bandwidth enforcer to control, via per-edge-network route installer instances, which shard will be used for carrying traffic between every pair of (source, destination) edge networks. In the event of a route installer failure or withdrawal of the route for prefix P from the route installer, the EBR supernode may fall back to the shard-learned route for prefix P. Cover prefix C may be used for reducing the amount of physical resources used by edge networkswitches. For example, EBR and superblock switches may carry only the cover route in their sharded VRFs. In some examples where forwarding behavior differs substantially between prefixes C and P, routes for prefix P may also be installed in the EBR. If forwarding behavior for prefix P needs to be substantially different from the cover prefix at one or more superblocks, IBR may install routes for P on the corresponding switches.

In distributing its outgoing traffic to different shards, the EBR supernode implements load balancing for both sharded and unsharded traffic. As one example for unsharded traffic, weighted cost multipath (WCMP) routing may be used at every EBR supernode to spread unsharded traffic across links to supernodes in Shard 1. The weights may be determined based on available bandwidth which will be included in the BGP route announcements received from every supernode. For sharded traffic, WCMP may be used across routers within each shard. Across shards, 0/1 equal cost multipath (ECMP) routing may be used for traffic distribution. For example, every EBR supernode may send either no traffic to a shard or it may send traffic that's equal to the amount sent to every other shard. Within each shard, the supernode may use WCMP to spread traffic among multiple routers.

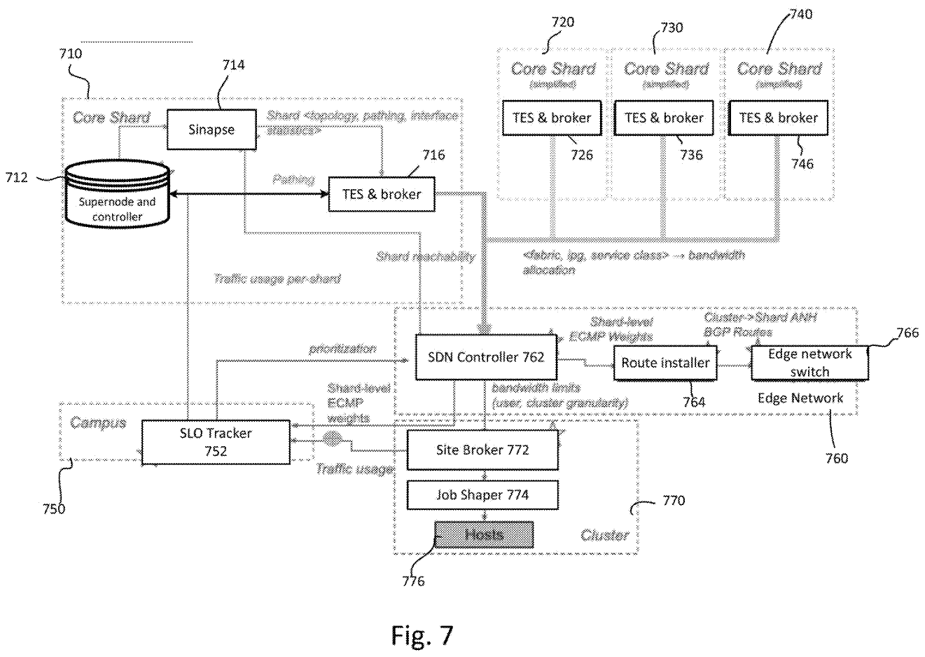

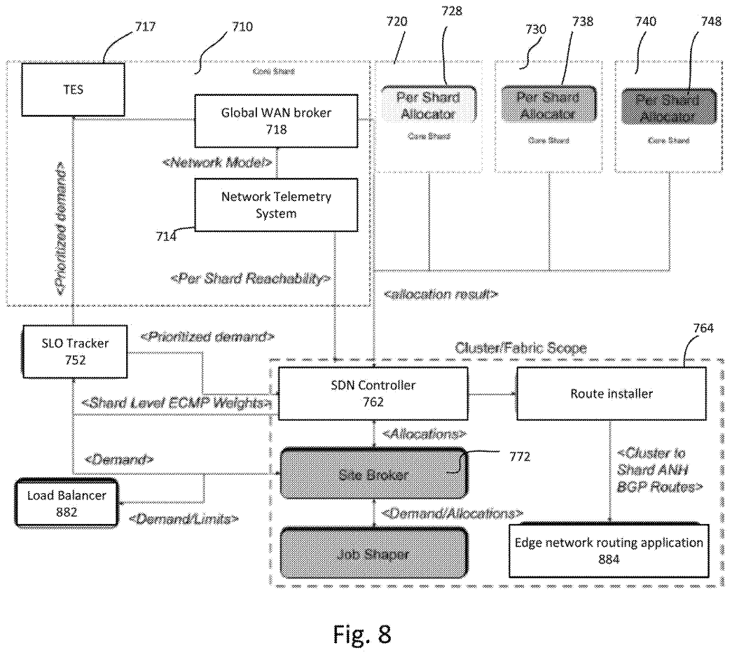

FIG. 7 is a block diagram of an example global and regional control plane. FIG. 8 is a block diagram of the bandwidth enforcer. These diagrams are explained together below. Core shards 710, 720, 730, 740 each communicate with SDN controller 762 in edge network 760. Each core shard 710-740 includes a supernode 712, network telemetry system 714, traffic engineering server (TES) 717, global WAN broker 718, and allocator 728, 738, 748.

The network telemetry system 714 may be a service that determines paths used by routers and switches for forwarding traffic. For example, the network telemetry system 714 may obtain this information from the forwarding tables of routers and switches. The network telemetry system 714 may be a real-time network telemetry system. It may observe network state, such as forwarding state in routers, packet counters, topology, port states, etc., and report such network state to consumers. The consumers may be, for example, global WAN broker, TES and SDN controller 762, etc. The network state may be communicated at the level of abstraction required by consumers, such as paths from forwarding and topology states., link usage stats from packet counter information, etc.

Regional and global network allocators are deployed per shard 710, 720, 730, 740. Zonal controllers, such as site broker 772 and job shaper 774, are not sharded or shard-aware. In addition to bandwidth enforcement functionality via host rate limiting, the bandwidth enforcer is capable of influencing the load balancing across shards by programming WCMP weights at the edge networks of the edge. SDN controller 762 and cross-shard edge gateway (route installer) 764 are zonal controllers deployed per edge network, and support the load balancing.

The SDN controller 762 is responsible for computing 0/1 ECMP weights based on per shard allocation result to protect user facing and streaming protected traffic from single shard failures. Per shard allocation result is based on network-aware per-shard bandwidth location by global/regional controllers, such as global broker 718, which uses the real time network topology, pathing, usage telemetry and network approvals for computing bandwidth allocation. The SDN controller 762 computes the shard unaware aggregate bandwidth allocation for sharded traffic which can be used for host rate limiting.

The SDN controller 762 may prohibit turning off more than a single shard for a destination. It may also limit for a given source edge network, the number of WCMP groups to be installed. In determining allocation, the SDN controller 762 may utilize inputs such as per-shard allocation from the global broker for each flow, prioritized demands and approvals from SLO tracker 752, reachability information from network telemetry system/NetSLO 714, and configuration, such as whether shards have been manually disabled. The SDN controller 762 creates a desired state, such as enabled or disabled, for each shard, taking into account the restrictions on WCMP granularity. This result is used to combine the allocation received from each shard 710-740 into a single allocation per network to be sent to site broker 772.

The route installer 764 programs the SDN controller computed weights at edge edge networks per prefix by communicating with the edge network via BGP.

Once the SDN controller 762 decides to turn off a shard for a given destination for a shard, in order for the bandwidth enforcer to detect the turned off shard is recovered, the bandwidth enforcer keeps allocating on the turned off shard. This requires global/regional brokers to receive demand, and therefore intended demand may be kept on the shards as if the shards are not turned off.

In the network due to routing failures an edge network can be disconnected from a shard which results in traffic falling back to other shards at network level. In order to accurately detect and allocate, the SDN controller 762 receives a signal provided via a per-edge-network, per-shard network telemetry systemdirectly to the SDN controller 762. During routing failures SDN controller 762 updates its internal state to turn off the shard to be in sync with the network state. SDN controller 762 explicitly signal edge networks to turn off the failed shard. When the network recovers and once SDN controller 762 detects the recovery, it will turn the failed shard back to carry traffic.

Site broker 772 is responsible for separating and reporting unsharded and sharded demand into different components. Site broker 772 receives limits for shard enabled flows via the SDN controller 762 while unsharded demand may come from the first shard. Both paths will use the same API for communication with site brokers.

As mentioned above, operational safety policies may be enforced by the SDN controller 762 to reduce a blast radius of failures and control and management operations, and to limit the scope of unintended operations. Examples of such policies may include a backstop, rate limits, scope limits, design rules, traffic fit check, etc. A backstop pauses non-mitigation network mutations for all shards in case of bad network health in one shard to prevent propagation of faults. Rate limits control frequency of network mutations and ensure enough gap between each operation to allow network health systems to detect health changes to signal other layers of the safety ecosystem, allowing worklows and operators time for observation and repair. Scope limits control a blast radius of network mutations. Design rules control intent and network state changes against a set of design rules such as asymmetry, capacity, invariant etc. Traffic fit check ensures sufficient capacity is available with accurate impact assessments before network mutations. Use both approvals and usage for fit checks. Policies may be enforced at per-shard scope as well as cross-shard which requires shard-awareness and global topology visibility.

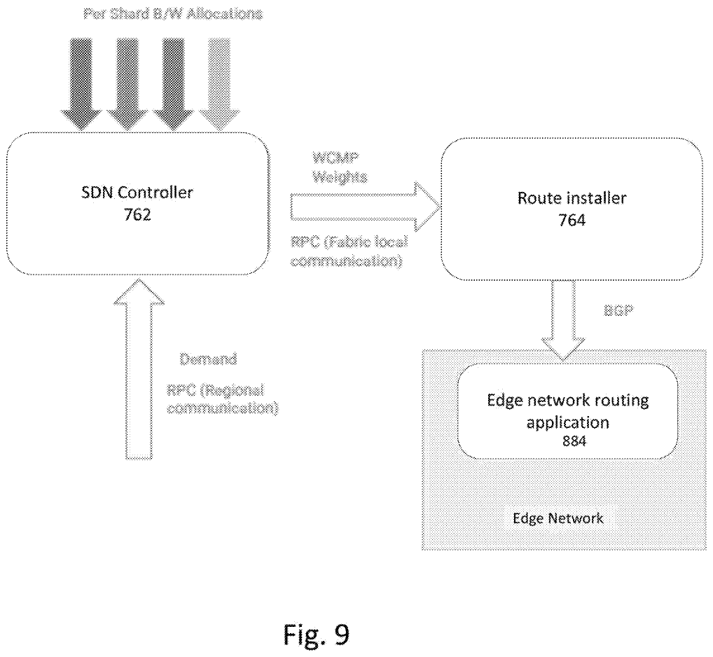

FIG. 9 provides a simplified view of the global and regional control plane components. As shown, the SDN controller 762 receives per-hard bandwidth allocations, as well as traffic demands. The SDN controller 762 determines the best WCMP configuration for the source edge network and destination edge network to increase demand satisfaction for shard protected traffic under shard failures based on in-profile demand and per-shard bandwidth allocations. Route installer 764 converts the weights into standardized networking protocol routes, such as BGP ECMP routes or gRIBI or other protocols, and announces the routes to distributed SDN platform routing application 884. The source and destination edge networks may be fabrics, clusters, datacenters, or any other network of computing devices.

Allocation by the SDN controller 762 may include creating an allocation input snapshot map keyed per destination, and including all relevant input data, such as reachability, prioritized demand, etc. WCMP computation may be performed per destination in parallel. WCMP configuration may be computed based on the relevant input data, as well as configuration overrides. Prioritization may be performed in any of a number of ways. For example, all shard protected traffic may be treated indiscriminately. As another example, SDN controller policy may define strict disjoint priority ordering. As another example, the SDN controller 762 policy may define priority ordering with configured fulfillment thresholds per SLO class.

The SDN controller 762 may maintain one or more WCMP weight states, such as an immediate WCMP state and a network WCMP state. In immediate WCMP, the WCMP weights are computed in each execution of the SDN controller 762 and reported to SLO trackers to be used for generating prioritized demand for network allocators in the next cycle. In network WCMP, weights are programmed into the network. The SDN controller 762 may select the best WCMP configuration for different types of traffic. The route installer picks up the weights and advertises them to its peers, such as the SDN platform routing application 884. In doing so, the route installer converts the weights to IP prefix to per shard abstract nexthop mapping, and communicates them to edge domains via BGP for hierarchical WCMP-based load balancing of edge-to-shard traffic.

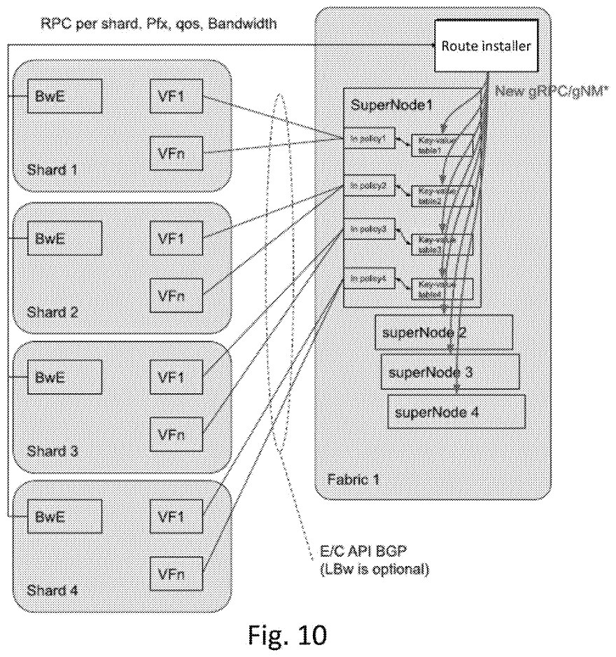

FIG. 10 illustrates an example of route installer communication. The route installer calculates per prefix value of link-bandwidth community and stored in in-memory tables of the edge domain which is running BGP. Each shard has a separate table, such as a key-value table where the key is the prefix and the value is the community. When a supernode learns path for a given prefix from the given shard, it processes it through ingress policy that references the key-value table specific for this shard, and overwrites or sets the link bandwidth community accordingly. Disabling the shard from load balancing could be done by setting the link bandwidth to 0, or by implementing an additional per-shard table that would set BGP attribute with low priority.

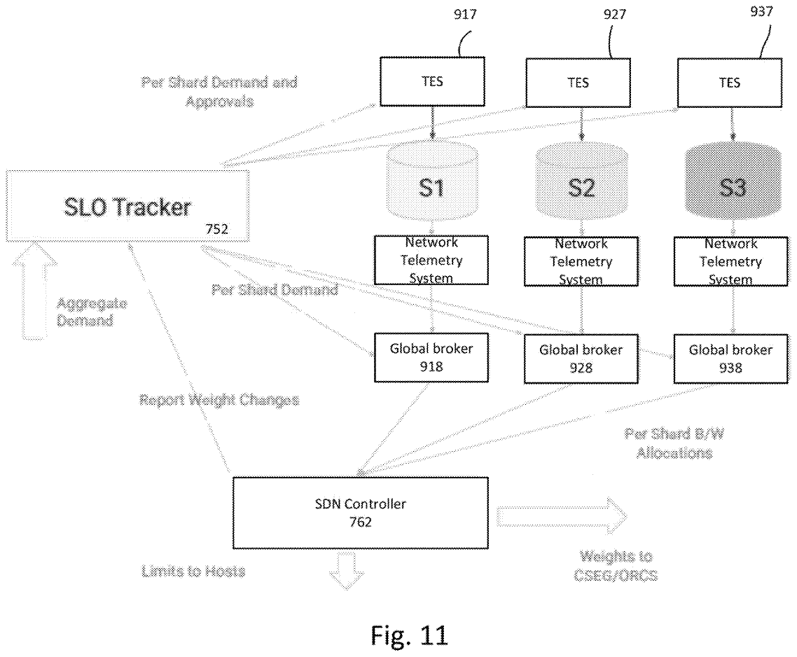

FIGS. 11-15 illustrate an example of a shard failure and response by the SDN controller. As shown in FIG. 11, traffic engineering components 917, 927, 937 install per-shard paths for shards S1, S2, S3, respectively, based on per-shard approvals and demands from SLO tracker 752. The network telemetry system reports observed path splits to global brokers 918, 928, 938, which determine per-shard bandwidth allocations based on per-shard demand and path splits. The SDN controller 762 determines aggregate bandwidth limits across shards and weights to be installed in edge network.

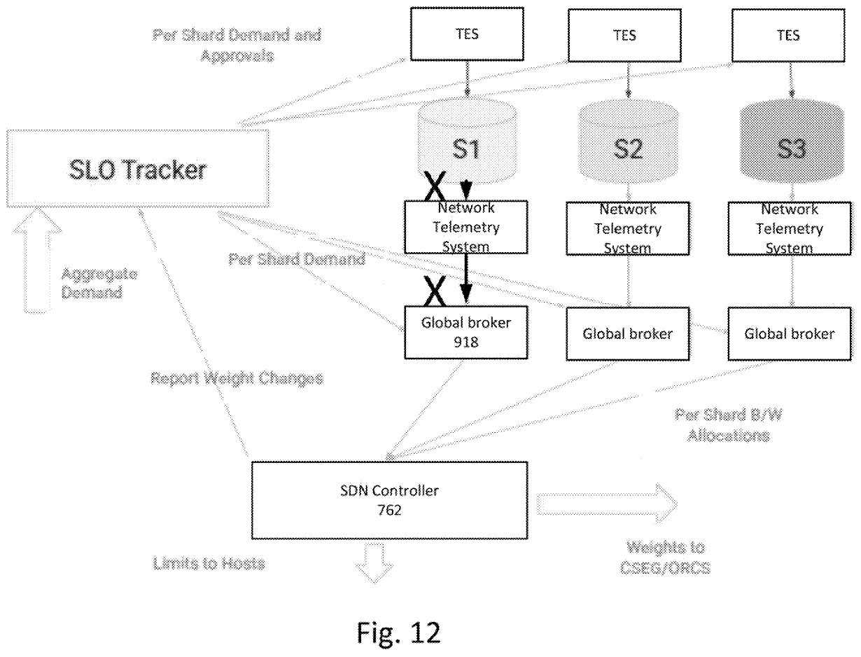

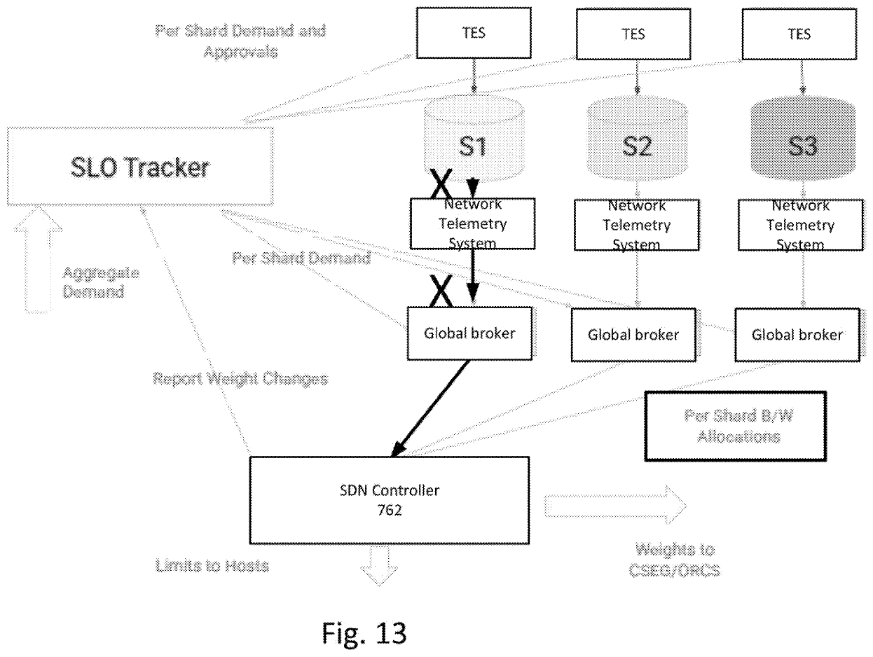

As shown in FIG. 12, shard S1 failure is observed by the network telemetry system, which reports an updated network model to the global broker 918. As shown in FIG. 13, the SDN controller 762 observes the reduction in bandwidth allocation from the global broker 918. The SDN controller 762 may determine to turn off shard S1 for impacted flows.

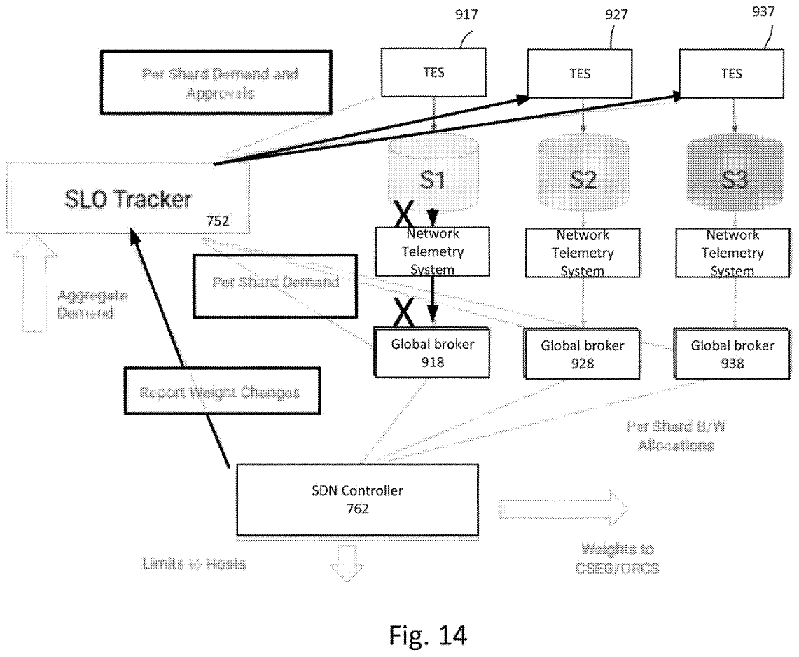

As shown in FIG. 14, the SDN controller 762 reports its expected weight changes to the SLO tracker 752, which adjusts the approvals and demand and reports to the traffic engineering components 917, 927, 937 and the global brokers 918, 928, 938. The demands and approvals may be inflated for healthy shards S2, S3. The failed shard S1 may have uninflated demand/approval. The traffic engineering components 917, 927, 937 may adjust paths to support new demand and approvals. The global brokers 918, 928, 938 may provide allocations using the adjusted demand.

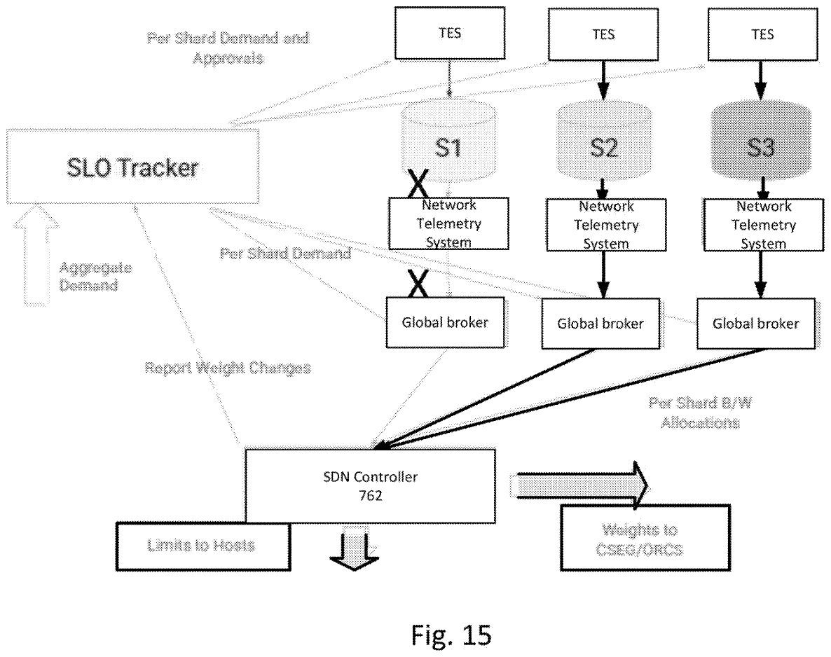

As shown in FIG. 15, after a few cycles the global brokers 918, 928, 938 may report that weight report intent is safe. The weight report intent may be a traffic distribution intent that the SDN controller 762 plans to program in the network. Accordingly, the SDN controller 762 sends WCMP weight change intent to route installer for installation in the network. Bandwidth limits may also be adjusted based on currently active shards.

The systems described above may be used to perform methods related to allocating flows among a plurality of shards in a global network. An example of such methods are described below. While operations of such methods are described in a particular order, the order may be modified. In some examples, operations may be performed in parallel. In some examples, operations may be added or omitted.

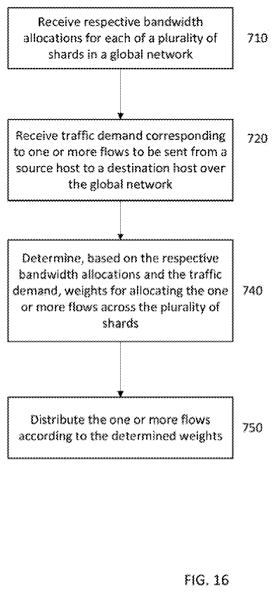

FIG. 16 illustrates an example method 1600. In block 1610, one or more processors receive respective bandwidth allocations for each of the plurality of shards. In block 1620, the one or more processors receive traffic demand corresponding to one or more flows to be sent from a source host to a destination host over the global network.

In block 1630, the one or more processors determine, based on the respective bandwidth allocations and the traffic demand, weights for allocating the one or more flows across the plurality of shards. Initial allocation may be performed by the SDN controller at the granularity of an individual flow. For example, the SDN controller creates an allocation input snapshot map. Weighting configuration may be computed based on parameters such as prioritized demand, reachability, bandwidth, etc. Weighting configurations may be determined sequentially for different classes of traffic, wherein configurations for lower classes can be ignored if they negatively impact demand satisfaction for a higher class of traffic. According to some examples, impact thresholds can be set, such that configurations are ignored only if they negatively impact higher traffic classes beyond the threshold level of demand satisfaction. From those determined weighting configurations, one or more configurations can be selected.

In block 1640, the one or more processors distribute the one or more flows according to the determined weights.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system, comprising:
one or more processors in communication with a plurality of global networks, the one or more processors configured to:
receive respective bandwidth allocations for each of the plurality of global networks;
receive traffic demand corresponding to one or more flows to be sent from a source to a destination over the global networks;
determine, based on the respective bandwidth allocations and the traffic demand, weights for allocating the one or more flows across the plurality of global networks; and
distribute the one or more flows according to the determined weights.

2. The system of claim 1, wherein the one or more processors comprise a software defined network (SDN) controller.

3. The system of claim 2, wherein the one or more processors further comprise a route installer, wherein the SDN controller is configured to communicate the determined weights to the route installer for distributing the one or more flows.

4. The system of claim 3, wherein the route installer is configured to convert the weights received from the SDN controller into standardized networking protocol routes.

5. The system of claim 4, wherein the route installer is further configured to communicate the standardized networking protocol routes to a standardized networking routing application.

6. The system of claim 2, wherein the SDN controller is configured to determine aggregate bandwidth limits across the plurality of shards, the aggregate bandwidth limits being used to determine the weights.

7. The system of claim 1, wherein the one or more processors comprise a service level objective (SLO) tracker, wherein the SLO tracker receives demands and provides information encoding a priority of the demands.

8. The system of claim 7, wherein each of the plurality of shards has a respective broker, the respective broker configured to receive the per-shard demand and determine bandwidth allocations based on the per-shard demand and observed path splits.

9. A method of allocating flows among a plurality of global networks, the method comprising:
receiving, at one or more processors, respective bandwidth allocations for each of the plurality of shards;
receiving, at the one or more processors, traffic demand corresponding to one or more flows to be sent from a source to a destination over the global network;
determining, at the one or more processors based on the respective bandwidth allocations and the traffic demand, weights for allocating the one or more flows across the plurality of shards; and
distributing, by the one or more processors, the one or more flows according to the determined weights.

10. The method of claim 9, wherein the one or more processors comprise a software defined network (SDN) controller.

11. The method of claim 10, wherein the one or more processors further comprise a route installer, further comprising communicating, by the SDN controller, the determined weights to the route installer for distributing the one or more flows.

12. The method of claim 11, further comprising converting, by the route installer, the weights received from the SDN controller into standardized networking protocol routes.

13. The method of claim 12, further comprising communicating, by the route installer, the standardized networking protocol routes to a standardized networking routing application.

14. The method of claim 10, further comprising determining, by the SDN controller, aggregate bandwidth limits across the plurality of shards, the aggregate bandwidth limits being used to determine the weights.

15. The method of claim 9, wherein the one or more processors comprise a service level objective (SLO) tracker, wherein the SLO tracker receives demands and provides information encoding a priority of the demands.

16. The method of claim 15, wherein each of the plurality of shards has a respective broker, the respective broker configured to receive the per-shard demand and determine bandwidth allocations based on the per-shard demand and observed path splits.

17. A non-transitory computer-readable medium storing instructions that, when executed by one or more processors, cause the one or more processors to perform operations for allocating flows among a plurality of global networks, the operations comprising:
receiving respective bandwidth allocations for each of the plurality of shards;
receiving traffic demand corresponding to one or more flows to be sent from a source to a destination over the global network;
determining, based on the respective bandwidth allocations and the traffic demand, weights for allocating the one or more flows across the plurality of shards; and
distributing the one or more flows according to the determined weights.
The non-transitory computer-readable medium of claim 9, wherein the one or more processors comprise a software defined network (SDN) controller.

18. The non-transitory computer-readable medium of claim 17, wherein the one or more processors further comprise a route installer, the operations further comprising communicating, by the SDN controller, the determined weights to the route installer for distributing the one or more flows.

19. The non-transitory computer-readable medium of claim 18, the operations further comprising converting, by the route installer, the weights received from the SDN controller into standardized networking protocol routes.

20. The non-transitory computer-readable medium of claim 19, the operations further comprising communicating, by the route installer, the standardized networking protocol routes to a standardized networking routing application.
